(19) United States
(12) Patent Application Publication
(10) Pub. No.: US 2011/0130239 A1
(43) Pub. Date: Jun. 2, 2011

(54) DIFFERENTIAL GEAR FOR VEHICLE AND VEHICLE

(75) Inventors: Koji SATO, Saitama (JP); Eiichi Suzuki, Saitama (JP); Bunzo Seki, Saitama (JP)

(73) Assignee: HONDA MOTOR CO., LTD, Tokyo (JP)

(21) Appl. No.: 12/958,804

(22) Filed: Dec. 2, 2010

(30) Foreign Application Priority Data
Dec. 2, 2009 (JP) 2009-274459

(51) Int. Cl. F16H 48/06

(52) U.S. Cl. 475/220

(57) ABSTRACT

A diff case is attached to a side face of a ring gear wheel on the opposite side to the side on which the ring gear wheel and a pinion gear wheel mesh with each other. The ring gear wheel integrally has a boss portion, in which a driven shaft is fitted, on the meshing side with the pinion gear wheel. An annular member slidably movable in an axial direction thereof is provided on the boss portion with a guide portion for guiding the annular member. A lock pin is provided on the annular member for inserting into pin holes formed in the ring gear wheel and a left output side cam to place the differential mechanism into a locked state. A sliding region within which the annular member slidably moves is disposed so as to be included in a projection region of the diameter of the pinion gear wheel

### CROSS-REFERENCE TO RELATED APPLICATIONS

The present application claims priority under 35 USC 119 to Japanese Patent Application No. 2009-274459 filed on Dec. 2, 2009 the entire contents of which are hereby incorporated by reference.

### BACKGROUND OF THE INVENTION

1. Field of the Invention

This invention relates to a differential gear for a vehicle which includes a mechanism (diff lock) for stopping differential motion and a vehicle which includes the differential gear.

2. Description of Background Art

A differential gear absorbs a difference in the number of revolutions between the left and the right driving wheels when a vehicle turns to allow the wheels to rotate by an individually suitable numbers of revolutions to distribute the driving torque to the wheels.

Such differential gears can be roughly grouped into those which have a popular differential mechanism called open diff and those which have a differential motion limiting mechanism called LSD (LSD: Limited Slip Differential). The open diff is frequently incorporated in a vehicle designed for traveling on leveled ground. A differential motion limiting mechanism is a mechanism which can limit differential motion when one of the left and the right driving wheels of a vehicle slips on a road surface having a low coefficient of friction thereby to assure a driving force of the other wheel on another road surface having a high frictional force. A four-wheel drive car designed for traveling on uneven ground or the like frequently incorporates a differential gear with a differential motion limiting mechanism.

Further, some differential apparatus include a mechanism (diff lock) for stopping the differential motion. This type of diff lock is a mechanism which temporarily stops the differential motion of the differential gear and unconditionally causes a driving torque to be distributed equally to the left and right wheels. The diff lock is caused to function typically in such a case when one of the left and right wheels slips on and cannot come out from a road surface having a low coefficient of friction such as a muddy spot. A four-wheel drive car or a vehicle which travels on uneven ground or the like frequently adopts a diff lock in a differential gear with a differential motion limiting mechanism. For example, Japanese Patent Laid-Open No. 2008-267561 discloses a differential gear which includes both of a differential motion limiting mechanism and a diff lock.

In addition, in the differential gear with a diff lock disclosed in Japanese Patent Laid-Open No. 2008-267561, a cylindrical portion extending in a vehicle widthwise direction is formed on a housing (diff case) in which a differential mechanism is accommodated and an annular member (sleeve) is fitted with the cylindrical portion for movement in an axial direction such that a pin interposed between the sleeve and the housing is moved by the sleeve and inserted into an output cam member, which composes the differential mechanism in the housing, to stop the differential motion.

However, with this mechanism, since the cylindrical portion which must sufficiently assure a stroke of movement of the sleeve is formed along a widthwise direction of the housing (vehicle widthwise direction), the widthwise dimension of the housing which has a comparatively large widthwise dimension is further elongated. Therefore, there is a problem that the overall size of the differential gear becomes to large and provides a restriction to the degree of freedom in layout of the vehicle.

### SUMMARY AND OBJECTS OF THE INVENTION

The present invention has been made in view of such a situation as described above, and it is an object of an embodiment of the present invention to provide a differential gear for a vehicle which can achieve miniaturization and can improve the degree of freedom in layout of the vehicle.

According to an embodiment of the present invention, a differential gear for a vehicle which includes a ring gear wheel 48 meshing with a pinion gear wheel 35 provided on a propeller shaft 25 which transmits a driving force from a driving source, a diff case 49 attached to a side face of the ring gear wheel and forming a differential mechanism chamber (for example, an accommodating space S2 in the embodiment), a differential mechanism (for example, a differential mechanism section 50 in the embodiment) accommodated in the diff case, a side gear wheel (for example, a left output side cam 65 in the embodiment) meshing with the differential mechanism for transmitting the driving force from the propeller shaft to wheels (for example, front wheels WF in the embodiment) through driven shafts (for example, front axles 31L, 32R in the embodiment) disposed on the left and the right, and a lock pin (for example, a lock pin 70 in the embodiment) for stopping the differential motion of the differential mechanism to place the differential mechanism into a locked state. The diff case is attached to a side face of the ring gear wheel opposite to the side on which the ring gear wheel and the pinion gear wheel mesh with each other. The ring gear wheel integrally has a boss portion (for example, a boss portion 54 in the embodiment), in which each of the driven shafts is fitted, on the meshing side thereof with the pinion gear wheel. The boss portion has an annular member 56 provided for sliding movement thereon along an axial direction of the boss portion and a guide portion 57 for guiding the annular member is set to the boss portion, and the lock pin is provided on the annular member such that, when the annular member slidably moves until the lock pin is inserted into pin holes 71, 72 formed in the ring gear wheel and the corresponding side gear wheel, the differential mechanism is placed into a locked state, and a sliding region ST within which the annular member slidably moves is disposed so as to be included within a projection region D of the diameter of the pinion gear wheel on an extension line of an end portion in an axial direction of the pinion gear wheel.

It is to be noted that, according to an embodiment of the present invention, the differential mechanism is not limited particularly in terms of the form but is of a concept including those of all forms including those of a structure with a differential motion limiting mechanism and those of a popular structure called open diff. While, according to an embodiment of the present invention, a medium which meshes with a differential mechanism and transits a driving force to the differential mechanism is referred to as side gear wheel, this side gear wheel includes, for example, a cam member where the differential mechanism is of the type with a differential motion limiting mechanism, but is not limited to a general side gear wheel used in an open diff and allows broad interpretation.

According to an embodiment of the present invention, the differential gear for a vehicle is characterized in that the differential gear includes a fork member 74 for engaging with the annular member in such a manner so as to sandwich a peripheral region of the annular member. A lever member 75 is secured to the fork member for moving the fork member along the axial direction of the boss portion in response to an operation of a passenger to move the annular member with a lever shaft 74A serving as a support shaft for the fork member and the lever member. The lever shaft is disposed on the opposite side to the diff case with respect to the ring gear wheel and on the opposite side to the pinion gear wheel with respect to the boss portion.

According to an embodiment of the present invention, the differential gear for a vehicle is characterized in that the pin hole formed in the side gear wheel is formed from an elliptic shallow hole portion 77 having a major axis in the direction of rotation of the ring gear wheel and a deep hole portion 78 of a diameter smaller than that of the shallow hole portion. A plurality of such pin holes are provided in the ring gear wheel.

According to an embodiment of the present invention, the differential gear for a vehicle is characterized in that the lock pin is formed from a large diameter portion 70A positioned on the bottom and a reduced diameter portion 70B having a diameter smaller than that of the large diameter portion. A plurality of such lock pins are provided on the annular member.

According to an embodiment of the present invention, the differential gear for a vehicle is characterized in that the pin hole formed on the ring gear is formed through the side face of the ring gear wheel along a circumferential direction of the ring gear wheel, and an annular groove 79 having a circumference same as that of the pin hole is formed on the side face of the ring gear wheel opposing to the side gear wheel along a locus of the pin hole of the side gear wheel.

According to an embodiment of the present invention, the differential gear for a vehicle is characterized in that the differential gear is for front wheels WF of a vehicle 1 which has seats S juxtaposed in a vehicle widthwise direction and an engine E disposed rearwardly of the seats and wherein the propeller shaft is disposed substantially at the center in the vehicle widthwise direction passing between the seats and besides a differential gear 30 for rear wheels WR is disposed in a displaced relationship to one side from the substantial center in the vehicle widthwise direction. The differential mechanism is disposed in a displaced relationship to the other side from the substantial center in the vehicle widthwise direction.

According to an embodiment of the present invention, a vehicle is characterized in that any one of the differential gears described above is mounted for front wheels WF of the vehicle 1 wherein the propeller shaft 25 is disposed at the substantial center in the vehicle widthwise direction and the differential mechanism 50 of the differential gear is disposed in a displaced relationship to one side from the substantial center in the vehicle widthwise direction while a differential gear 30 for rear wheels WR is disposed in a displaced relationship to the other side from the substantial center in the vehicle widthwise direction.

According to an embodiment of the present invention, the vehicle is characterized in that a trailer hitch 24B is provided on a vehicle body frame (for example, a rear cross member 24A in the embodiment) at a rear end of the center in the vehicle body widthwise direction. The differential gear for the rear wheels is disposed in a displaced relationship in such a manner so as to overlap with one of the left and the right of the trailer hitch as viewed from sidewardly.

According to an embodiment of the present invention, since the differential mechanism is placed into a locked state by the ring gear wheel and the side gear wheel which are high-strength members, the rigidity can be assured and the differential gear may not be formed heavy or thick.

Further, since the meshing portion with the propeller shaft, the boss portion and the annular member and the lock pin which are attached to the boss portion are provided on the opposite side to the diff case side which is comparatively large with respect to the ring gear wheel. Thus, the distance between the end portion of the propeller shaft and the driven shaft, that is, the length in the vehicle forward and backward direction, can be reduced.

In short, if the meshing portion of the ring gear wheel is positioned on the attachment side of the ring gear wheel to the diff case, it is necessary to increase the dimension of the ring gear wheel in the diametrical direction by an amount corresponding to the thickness of the differential mechanism and the diff case which accommodates the differential mechanism. Therefore, the distance between the end portion of the propeller shaft and the driven shaft increases as much. However, if the meshing portion and so forth are provided on the side face of the ring gear wheel opposite to the attachment side of the diff case, then the diameter of the ring gear wheel can be reduced without being restricted by the thickness of the differential mechanism and the diff case. Further, since also the end portion of the propeller shaft can be extended to the differential gear side and disposed, the distance between the end portion of the propeller shaft and the driven shaft, that is, the length in the vehicle widthwise direction, can be reduced.

Further, since the guide portion (boss portion) of the annular member having the lock pin which requires a predetermined length (stroke) is provided on the meshing side of the ring gear wheel with the propeller shaft, the guide portion can be provided forwardly or rearwardly of the end portion of the propeller shaft (where the differential gear is disposed on the front wheel side, the guide portion can be provided forwardly, but where the differential gear is disposed on the rear wheel side, the guide portion can be provided rearwardly), and here, the sliding region of the annular member is disposed on the extension line of the end portion in the axial direction of the pinion gear wheel such that it is included in the projection region of the diameter of the pinion gear wheel. Therefore, the region in the diametrical direction of the propeller shaft can be made the most of to reduce the width of the differential gear.

As a result, miniaturization of the differential gear can be achieved, and the degree of freedom in layout of the vehicle can be improved.

According to an embodiment of the present invention, compaction of the differential gear can be achieved. In particular, the space on the opposite side to the diff case with respect to the ring gear wheel and on the opposite side to the pinion gear wheel with respect to the boss portion can be made a dead space because there is no necessity to provide principal components of the differential gear therein. However, if the lever shaft which is part of the moving mechanism for the annular member and the lock pin is disposed there, then the dead spaced can be utilized effectively. Therefore, further compaction of the differential gear can be achieved in comparison with an alternative case wherein the lock pin, lever member and so forth are attached to the diff case side, and the length of the differential gear in the forward and backward direction and in the leftward and rightward direction can be reduced.

According to an embodiment of the present invention, insertion of the lock pin can be facilitated. Thus, the rigidity of the lock pin can be assured. Further, the burr which appears in the pin hole of the side gear by insertion and removal of the lock pin can escaped from the groove. Consequently, the burr can be prevented from interfering with the ring gear wheel.

According to an embodiment of the present invention, since the differential mechanism which is a heavy article is disposed in a distributed manner across the substantial center in the vehicle widthwise direction, the leftward and rightward weight balance of the vehicle body can be improved. Further, while interference between the differential gear for the rear wheels and, for example, the trailer hitch disposed at the center of the vehicle at a rear portion of the vehicle is avoided, the trailer hitch can be disposed in a displaced relationship to the front side. Consequently, the length in the forward and backward direction of the vehicle can be reduced.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a plan view showing a general configuration of a vehicle according to an embodiment of the present invention;

FIG. 2 is a transverse sectional view of a front final assembly in which a differential gear according to the embodiment of the present invention is built;

FIG. 3 is an enlarged sectional view of part of FIG. 2;

FIG. 4 is a vertical sectional view of the differential gear;

FIG. 5 is a view of part of the differential gear as viewed from below;

FIG. 6 is a view of part of the differential gear as viewed obliquely from below;

FIG. 7 is a view showing a lock pin provided on the differential gear;

FIG. 8 is a left side elevational view of the differential gear;

FIG. 9 is a view showing a ring gear provided on the differential gear; and

FIG. 10 is a view showing a left output side cam provided on the differential gear.

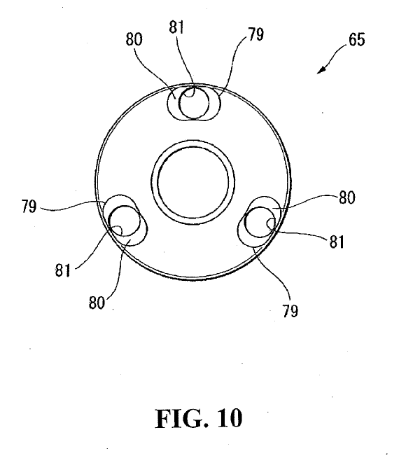

### DETAILED DESCRIPTION OF THE PREFERRED EMBODIMENTS

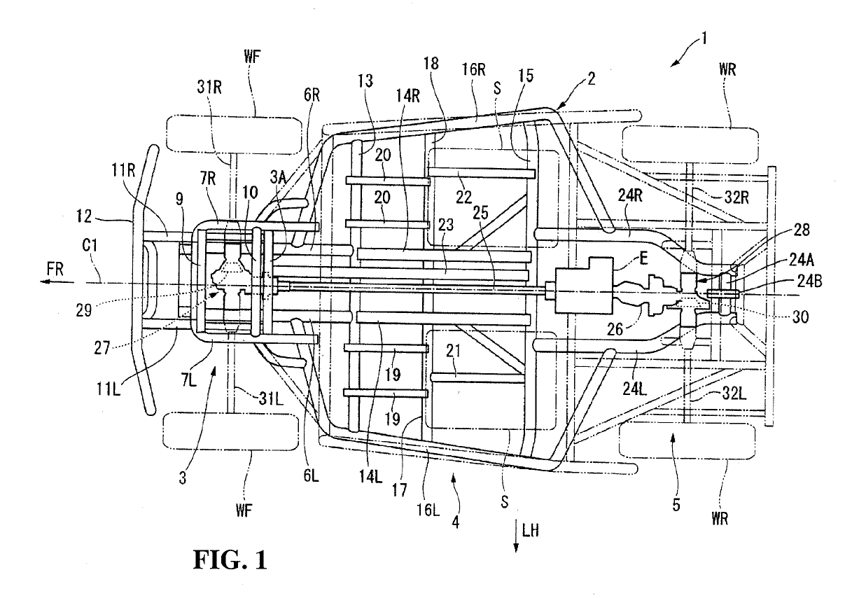

In the following, an embodiment of the present invention is described. FIG. 1 is a plan view showing a general configuration of a vehicle 1 which includes a differential gear according to the present invention. In the drawings, an arrow mark RF indicates the forward direction of the vehicle and another arrow mark LH indicates the leftward direction of the vehicle. Further, a center line CL of the vehicle 1 is indicated in the vehicle widthwise direction.

The vehicle 1 is formed as a vehicle (MUV) of a comparatively small size designed principally for traveling on uneven ground and has a vehicle body frame 2 which configures a basic skeleton of the vehicle. The vehicle body frame 2 is configured from a front frame section 3 suspending front wheels WF thereon, a center frame section 4 provided rearwardly of the front frame section 3 and forming a space in which seats S for passengers and so forth are disposed, and a rear frame section 5 provided rearwardly of the center frame section 4 for suspending rear wheels WR and for supporting an engine E.

The front frame section 3 has a pair of left and right front lower frames 6L and 6R extending in the forward and backward direction at a front portion of a lower portion of the vehicle, and a pair of left and right front upper frames 7L and 7R extending uprightly from front end portions of the front lower frames 6L and 6R and bent so as to extend rearwardly upwards. A first sub-cross frame 9 is provided below a location between the front upper frames 7L and 7R, and a second sub-cross frame 10 is provided above the location between the front upper frames 7L and 7R.

A pair of left and right bumper supporting pipes 11L and 11R are provided forwardly of the front lower frames 6L and 6R, and a bumper 12 extending leftwardly and rightwardly is secured to front ends of the bumper supporting pipes 11L and 11R. Further, a plurality of inverted frames (not shown) as reinforcing members are provided between the front lower frames 6L and 6R and the front upper frames 7L and 7R, and a plurality of cross frames extending in the leftward and rightward direction are provided at suitable locations of such inverted frames as just described. A front sub-cross frame 3A is provided on the inverted frames not shown.

The center frame section 4 has a first lower cross frame 13 connected to rear ends of the front lower frames 6L and 6R and extending in the vehicle widthwise direction, a pair of left and right central lower frames 14L and 14R extending rearwardly from a substantially central region of the first lower cross frame 13, a second lower cross frame 15 connected to rear ends of the central lower frames 14L and 14R and extending in the vehicle widthwise direction, and a pair of left and right side frames 16L and 16R connected to the opposite end portions of the first lower cross frame 13 and the second lower cross frame 15 and extending in the vehicle forward and backward direction. The side frames 16L and 16R are bent to the inner side in the vehicle widthwise direction from the connecting positions thereof to the first lower cross frame 13 and are connected at front ends thereof to the front lower frames 6L and 6R of the front frame section 3. Further, rear ends of the side frames 16L and 16R are bent to the inner side in the vehicle widthwise direction from the connecting positions thereof to the second lower cross frame 15 and are connected to rear lower frames 24L and 24R hereinafter described.

The central lower frames 14L and 14R are disposed at positions offset by a predetermined distance from the vehicle center line C1 in the vehicle widthwise direction and are disposed so as to be distributed to the left and right at equal distances from the vehicle center line C1. A left sub-cross frame 17 and a right sub-cross frame 18 are provided between the central lower frame 14L and the side frame 16L and between the central lower frame 14R and the side frame 16R, respectively. The left sub-cross frame 17 and the right sub-cross frame 18 are positioned substantially at the center between the first lower cross frame 13 and the second lower cross frame 15.

Sub-frames 19, 19 as reinforcing members juxtaposed with each other in the vehicle widthwise direction and extending in the vehicle forward and backward direction are provided between the left sub-cross frame 17 and the first lower cross frame 13, and sub-frames 20, 20 as reinforcing members juxtaposed in the vehicle widthwise direction and extending in the vehicle forward and backward direction are provided between the right sub-cross frame 18 and the first lower cross frame 13. Further, a sub-frame 21 as a reinforcing member extending in the vehicle forward and backward direction is provided between the left sub-cross frame 17 and the second lower cross frame 15, and another sub-frame 22 as a reinforcing member extending in the vehicle forward and backward direction is provided between the right sub-cross frame 18 and the second lower cross frame 15. The seats S are disposed in such a manner so as to extend over the left sub-cross frame 17, second lower cross frame 15 and sub-frame 21 and over the right sub-cross frame 18, second lower cross frame 15 and sub-frame 22 and are juxtaposed with each other in the vehicle widthwise direction.

A center frame 23 extending forwardly of the vehicle is connected to a substantially central region of the second lower cross frame 15. The center frame 23 is connected at a front end thereof to the front cross frame 3A of the front frame section 3. The center frame 23 extends straightforwardly in the vehicle forward direction passing a location between the central lower frame 14R and the vehicle center line C1 in the vehicle widthwise direction. In other words, the center frame 23 is disposed in an offset relationship by a predetermined distance from the vehicle center line C1 to the right side.

The rear frame section 5 is configured from a pair of left and right rear lower frames 24L and 24R extending rearwardly from a substantially central region of the second lower cross frame 15 with a plurality of cross frames not shown provided on the rear lower frames 24L and 24R, and so forth. The rear lower frames 24L and 24R are formed in a curve such that the distance therebetween decreases rearwardly of the vehicle, and rear ends thereof are coupled to each other by a rear cross member 24A. The rear cross member 24A has a trailer hitch 24B provided thereon such that it has a longitudinal direction along the vehicle center line C1.

The engine E is formed as a water-cooled engine and is carried in a so-called transversely mounted state above the rear lower frames 24L and 24R rearwardly of the seats S. A front propeller shaft 25 for transmission of driving power is provided at a front portion of a crankcase (not shown) of the engine E such that it extends forwardly, and a rear propeller shaft 26 is provided at a rear portion of the crankcase such that it extends rearwardly.

The front propeller shaft 25 extends straightforwardly on the vehicle center line C1 between the seats S and is connected to a front final assembly 27 provided on the front frame section 3. The rear propeller shaft 26 has a length set comparatively short and extends leftwardly rearwards from the vehicle center line C1 such that it is connected to a rear final assembly 28 provided on the rear frame section 5. The rear propeller shaft 26 is configured so as to extend leftwardly rearwards by interposing a universal joint or the like between the engine E and the rear final assembly 28. A rear end of the rear final assembly 28 connected to the rear propeller shaft 26 extends rearwardly to a location in the proximity of the rear cross member 24A, and a trailer hitch 24B extending forwardly along the vehicle center line C1 is provided on the rear cross member 24A. Therefore, in the vehicle 1 of the present embodiment, the rear propeller shaft 26 extends leftwardly and rearwards and the rear final assembly 28 is disposed in a leftwardly displaced (offset) relationship from the vehicle center line C1 to avoid interference between the rear final assembly 28 and the trailer hitch 24B. In other words, the rear final assembly 28 is disposed in a displaced relationship so as to overlap leftwardly of the trailer hitch 24B as viewed in a side elevation.

A front wheel differential gear 29 is built in the front final assembly 27, and a rear wheel differential gear 30 is built in the rear final assembly 28. Front axles 31L and 31R extending in the leftward and rightward direction are connected at one end thereof to the front wheel differential gear 29, and rear axles 32L and 32R extend in the leftward and rightward direction are connected at one end thereof to the rear wheel differential gear 30. The front axles 31L and 31R have the paired left and right front wheels WF attached to the other end thereof and the rear axles 32L and 32R have the paired left and right rear wheels WR attached to the other end thereof. In such a configuration as just described, power from the engine E is transmitted to the front wheels WF through the “front propeller shaft 25”→“front wheel differential gear 29”→“front axles 31L and 31R” in order and transmitted to the rear wheels WR through the “rear propeller shaft 26”→“rear wheel differential gear 30”→“rear axles 32L and 32R” in order.

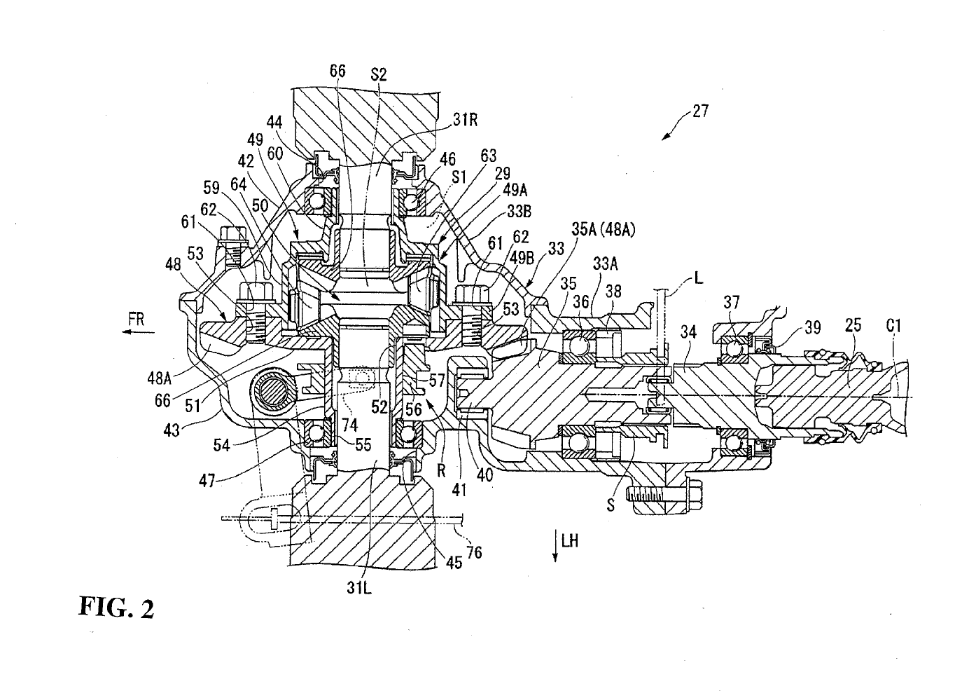

FIG. 2 shows a transverse section of peripheries of the front final assembly 27 which has the front wheel differential gear 29 built therein. The front wheel differential gear 29 according to the present invention is accommodated in a case part of the front final assembly 27.

The case part of the front final assembly 27 which has the front wheel differential gear 29 built therein is described. The front final assembly 27 has a housing 33 for accommodating the front wheel differential gear 29. The housing 33 is configured from a cylindrical case portion 33A positioned on the rear side of the vehicle, and a differential gear case body portion 33B positioned on the front side of the vehicle.

The cylindrical case portion 33A is disposed such that the axial direction thereof extends along the vehicle center line C1 and accommodates a pinion gear wheel 35 connected to a front end of the front propeller shaft 25 through a joint 34. Bearings 36 and 37 are fitted in the inside of a front portion and the inside of a rear portion of the cylindrical case portion 33A such that the pinion gear wheel 35 and the joint 34 are supported for rotation in the cylindrical case portion 33A by the bearings 36 and 37, respectively.

A lock nut 38 is provided rearwardly of the bearing 36 such that the bearing 36 is fixed at a predetermined position by the lock nut 38. A seal member 39 is provided on the inner side of the cylindrical case portion 33A rearwardly of the bearing 37 such that the gap between the cylindrical case portion 33A and the joint 34 is closed up. Further, a cylindrical end portion 40 is provided in a projecting manner at a head portion of the pinion gear wheel 35. The end portion 40 is fitted in and supported for rotation on a bearing 41 inserted in a perforation formed in the differential gear case body portion 33B.

A sleeve S is provided for movement in an axial direction (in the forward and backward direction) on the base end side of the pinion gear wheel 35, and a lever member L is held in engagement with the sleeve S. The lever member L moves the sleeve S in the axial direction so that the sleeve S can be brought into and out of engagement with the joint 34. Consequently, the vehicle 1 is configured for changeover between four-wheel driving and two-wheel driving.

The cylindrical case portion 33A and the differential gear case body portion 33B are internally communicated with each other, and an umbrella-shaped meshing portion 35A of the pinion gear wheel 35 is partly exposed to an accommodating space Si formed by the differential gear case body portion 33B. The differential gear case body portion 33B is divided into a cup-shaped right half 42 which configures the right side portion and a left half 43 which configures the left side portion and closes up the opening of the right half 42. The accommodating space Si is formed by cooperation of the right half 42 and the left half 43.

In the differential gear case body portion 33B, the right half 42 has such a shape that the diameter thereof decreases in the rightward direction and has an opening 44 at a right side end portion thereof. Meanwhile, an opening 45 is formed at a left side end portion of the left half 43. The openings 44 and 45 are fitted with the front axles 31R and 31L, respectively, and the front axles 31R and 31L fitted in the differential gear case body portion 33B pass through the openings 44 and 45 and are connected to the front wheel differential gear 29.

Bearings 46 and 47 are provided on the inner side of the opening 44 of the right half 42 and the opening 45 of the left half 43 such that the centers thereof extend in the axial directions of the openings 44 and 45, respectively. The bearings 46 and 47 support the front wheel differential gear 29 for rotation in the inside of the differential gear case body portion 33B. The bearings 46 and 47 are fitted in the inside of the right half 42 and the inside of the left half 43, respectively. The inner diameter of the bearings 46 and 47 is set greater than the outer diameter of the front axles 31R and 31L such that the front axles 31R and 31L passing through the openings 44 and 45 extend to the front wheel differential gear 29 through the bearings 46 and 47, respectively.

In the following, the front wheel differential gear 29 is described in detail. The front wheel differential gear 29 is accommodated in the differential gear case body portion 33B in such a manner as described above and is supported for rotation on the differential gear case body portion 33B. In the present embodiment, the front wheel differential gear 29 is configured as a differential gear having a differential motion limiting mechanism (LSD: Limited Slip Differential).

The front wheel differential gear 29 has a ring gear wheel 48 meshing with the pinion gear wheel 35 provided on the front propeller shaft 25, a diff case 49 provided on a side face of the ring gear wheel 48 and forming a fixed space, and a differential mechanism section 50 accommodated in the diff case 49. The differential mechanism section 50 substantially configures a differential mechanism which absorbs a difference in the number of revolutions between the left and right driving wheels to distribute driving torque to the wheels while generating the rotation of a number of revolutions individually suitable for the wheels.

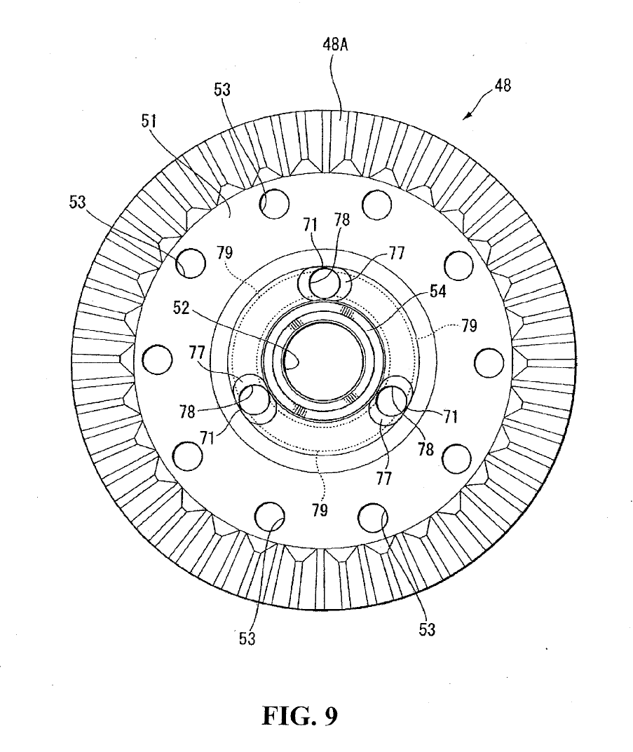

The ring gear wheel 48 includes a ring gear wheel body portion 51 in the form of a disk, and a fitting hole 52 for allowing the front axle 31L or the like to be fitted therein that is formed at a substantially central region of the ring gear wheel body portion 51. A meshing portion 48A for meshing with the pinion gear wheel 35 is formed on an outer circumferential edge side of the ring gear wheel body portion 51 (refer also to FIG. 9).

A plurality of diff case attaching holes 53, . . . are formed on a side face of the ring gear wheel body portion 51 on the inner circumferential side with respect to the meshing portion 48A wherein they extend in the leftward and rightward direction through the side face. The plurality of diff case attaching holes 53, . . . are formed in a spaced relationship by a predetermined distance from each other in a circumferential direction of the ring gear wheel body portion 51. Further, a cylindrical boss portion 54 extending to the left side in the vehicle widthwise direction is formed integrally on a circumferential edge of the fitting hole 52 of the ring gear wheel 48, and a free end side (left end portion side) of the boss portion 54 is set as a pivotally supporting portion 55 for being fitted by the bearing 47 provided on the inner side of the opening 45 of the left half 43. Consequently, the front wheel differential gear 29 is supported for rotation on the differential gear case body portion 33B.

To a region of an outer circumferential face of the boss portion 54 which extends from a lower portion to a substantially central portion (where the figure is referred to, a predetermined region extending toward the rightward direction from a left end portion), a guide portion 57 of an annular member 56 forms a diff lock R hereinafter described. The guide portion 57 guides the annular member 56 inserted in the boss portion 54 for movement in the axial direction of the boss portion 54. Details of the diff lock R and so forth are hereinafter described. Further, the boss portion 54 has the front axle 31L fitted in the cylindrical inner side thereof and also as a function as a cover member of the front axle 31L.

The ring gear wheel 48 is configured in such a manner as described above. The diff case 49 attached to this ring gear wheel 48 has a hat-shaped cross sectional shape and is configured from a diff case body portion 49A formed cylindrically, and a flange portion 49B formed so as to extend diametrically from a circumferential edge of an end portion of the diff case body portion 49A.

The diff case body portion 49A is configured from a cylindrical accommodating portion 59 for accommodating most parts of the differential mechanism section 50, and a cylindrical rotatably supporting portion 60 projecting from an inner side region of a head portion (where the figure is referred to, a right side end face) of the accommodating portion 59. The rotatably supporting portion 60 is a portion for being fitted with the bearing 46 provided on the inner side of the opening 44 of the right half 42 and allows the front axle 31R to be fitted in the cylindrical inside thereof. The front wheel differential gear 29 is supported for rotation on the differential gear case body portion 33B by the rotatably supporting portion 60.

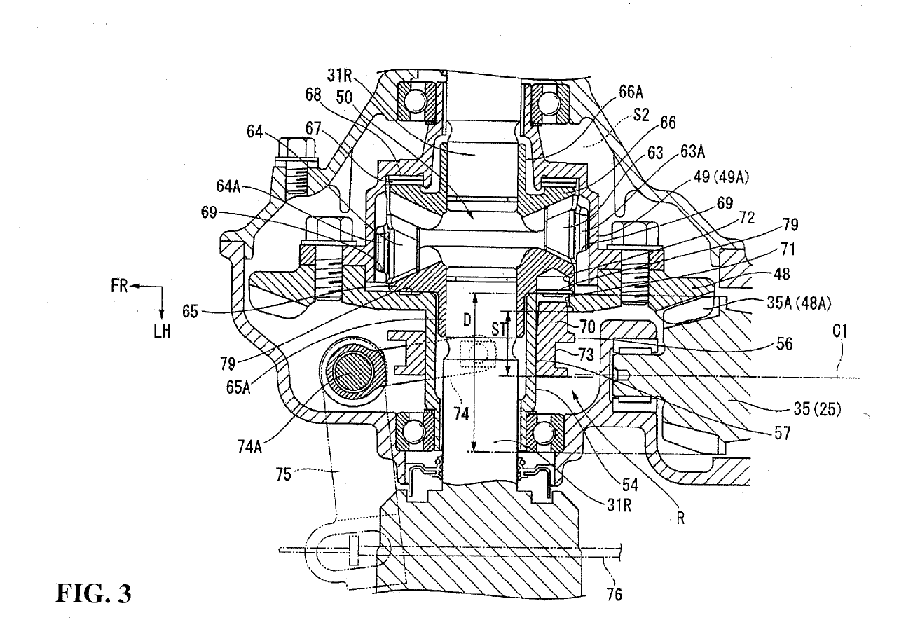

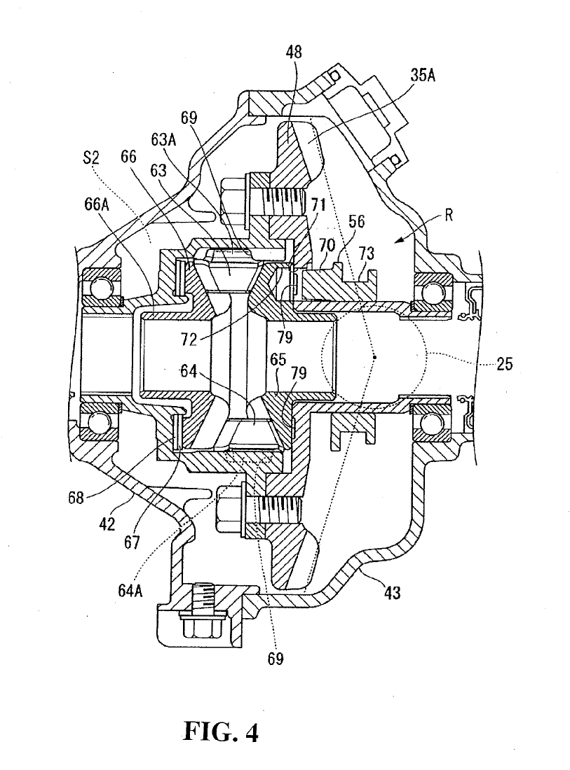

The flange portion 49B is provided for attachment to the ring gear wheel 48 and has a plurality of fitting holes 61, . . . formed in a spaced relationship by a predetermined distance from each other in a circumferential direction of the flange portion 49B. The fitting holes 61, . . . are formed on a concentric circle of the diff case attaching holes 53, . . . of the ring gear wheel body portion 51. The diff case 49 is attached by fastening of bolts 62 fitted in the fitting holes 61, . . . and the diff case attaching holes 53, . . . aligned with each other to the ring gear wheel 48. In particular, the diff case 49 is attached to a side face of the ring gear wheel 48 opposite to the side on which the ring gear wheel 48 and the pinion gear wheel 35 mesh with each other.

Where the ring gear wheel 48 and the diff case 49 are coupled to each other, a closed up accommodating space S2 is formed between them, and the differential mechanism section 50 is accommodated in the accommodating space S2. In the following, the differential mechanism section 50 is described in detail with reference particularly to FIGS. 3 and 4.

The differential mechanism section 50 includes two kinds of input side blocks 63, . . . and 64, . . . which rotate integrally with the diff case 49, left and right output side cams 65 and 66 sandwiching the input side blocks 63, . . . and 64, . . . for relative slipping movement therebetween and capable of being rotated independently of each other by frictional force with the blocks 63, . . . and 64, . . . , a thrust shaft 67 disposed adjacent the right output side cam 66, and a disk spring 68 disposed adjacent the thrust shaft 67.

The right output side cam 66 is disposed on the inner side of the accommodating portion 59 of the diff case 49 through the thrust shaft 67 and the disk spring 68. The input side blocks 63, . . . and 64, . . . are juxtaposed with each other in a circumferential direction of the diff case 49 in a contacting relationship with the right output side cam 66. The left output side cam 65 is disposed in the diff case 49 in a contacting relationship with the input side blocks 63, . . . and 64, . . . .

The input side blocks 63, . . . and 64, . . . include projections 63A and 64A, respectively, and can rotate integrally with the diff case 49 with the projections 63A and 64A thereof fitted in a plurality of grooved portions 69, . . . formed in a direction of an inner circumferential face of the diff case 49. Further, the input side blocks 63, . . . and 64, . . . can move in the axial direction of the diff case 49. Meanwhile, the left and right output side cams 65 and 66 have cylindrical portions 65A and 66A projecting leftwardly and rightwardly, respectively, and transmit driving force to the front wheels WF with the cylindrical portions 65A and 66A thereof spline-fitted with the front axles 31L and 31R, respectively.

The differential mechanism section 50 is configured in such a manner as described above. In such differential mechanism section 50, when no difference in the number of rotations appears between the left output side cam 65 and the right output side cam 66, the input side blocks 63, . . . and 64, . . . and the left and right output side cams 65 and 66 do not rotate relative to each other but rotate integrally. On the other hand, if a difference in speed of rotation, that is, in the number of revolutions, appears between the left output side cam 65 and the right output side cam 66, then the input side blocks 63, . . . and 64, . . . make relative movement, that is, relative rotation, while generating frictional force with the left and right output side cams 65 and 66, respectively. Therefore, driving torque can be distributed to the left and right output side cams 65 and 66 at different magnitudes of a predetermined ratio depending upon the directions of the frictional force which varies in response to relative slips between the input side blocks 63, . . . and 64, . . . and the left and right output side cams 65 and 66 depending upon the numbers of revolution of the two left and right output side cams 65 and 66. Accordingly, even if the driving force to one of the wheels decreases as a result of variation of the frictional coefficient of the road surface, the driving force to the other wheel does not drop, and the total driving force can be assured. Further, although a slip appears independently between the input side blocks 63, . . . and 64, . . . and the left output side cam 65 and between the input side blocks 63, . . . and 64, . . . and the right output side cam 66, differential motion the between the left and right wheels is limited by the frictional force upon slipping.

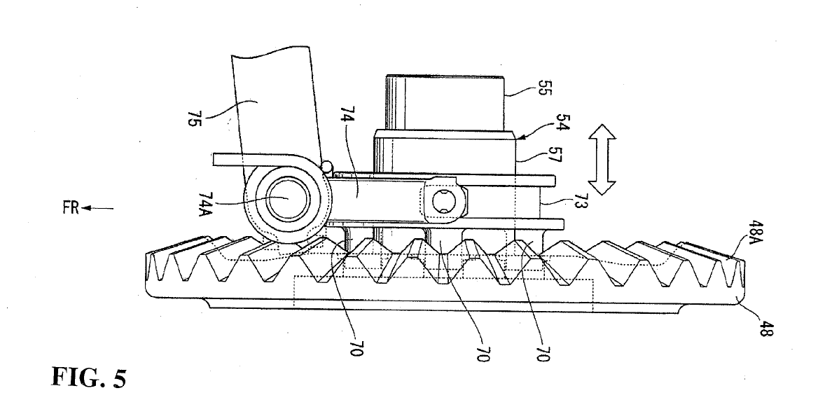

Referring continuously to FIGS. 3 and 4, in the present embodiment, a mechanism for stopping the differential motion (the mechanism is hereinafter referred to as diff lock R) is provided in the front wheel differential gear 29. This diff lock R is configured from the annular member 56 shown also in FIG. 2 and a lock pin 70 provided on the annular member 56, and stops the differential motion of the differential mechanism section 50 by inserting the lock pin 70 into a pin hole 71 formed in the ring gear wheel 48 and a pin hole 72 formed in the left output side cam 65. In the following, the diff lock R is described in detail with reference also to FIGS. 5 to 9.

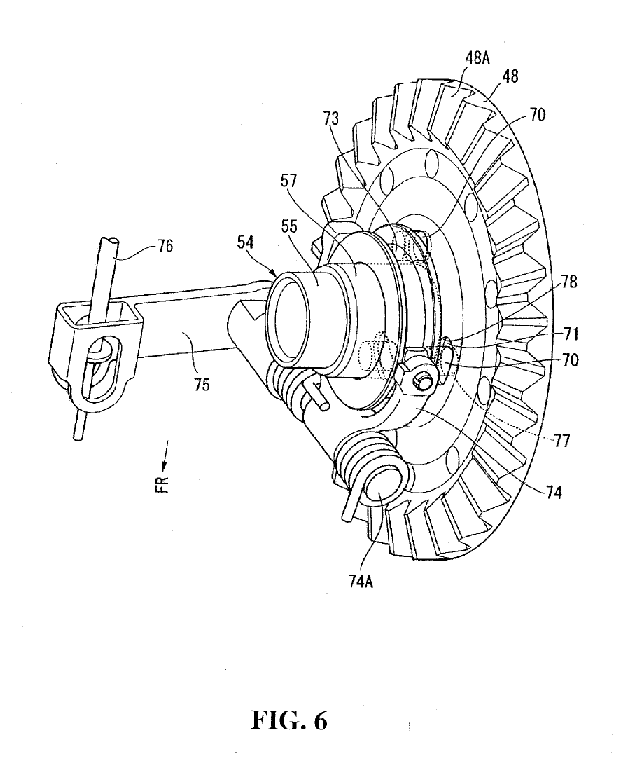

Referring also to FIGS. 5 and 6, the annular member 56 is fitted with the guide portion 57 set to an outer circumferential face of the boss portion 54 as described hereinabove and disposed for movement (sliding movement) along the axial direction of the guide portion 57 (refer to a double-side arrow mark in FIG. 5). More particularly, the annular member 56 is fitted with the boss portion 54 formed integrally on the side face of the ring gear wheel 48 on the meshing side with the pinion gear wheel 35 so as to be movable in the leftward and rightward direction, that is, along the axial direction of the boss portion 54. Referring here to FIG. 3, a region of sliding movement ST of the annular member 56 on the boss portion 54 is provided together with a projection region D indicative of the width in the diametrical direction of the pinion gear wheel 35. More particularly, the sliding region ST within which the annular member 56 slidably moves is disposed on an extension line of an end portion in the axial direction of the pinion gear wheel 35 such that it remains within the projection region D of the diameter of the pinion gear wheel 35.

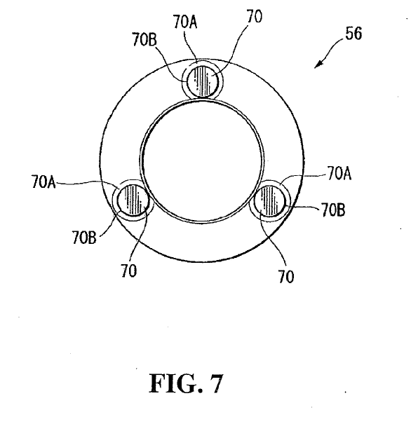

The lock pin 70 is provided integrally on an end face of the annular member 56 on the ring gear wheel 48 side, and three such lock pins 70 are formed at intervals of 120 degrees in a circumferential direction of the annular member 56 as shown in FIG. 7. Each lock pin 70 is configured from a large diameter portion 70A positioned on the bottom thereof, and a reduced diameter portion 70B of a diameter smaller than that of the large diameter portion 70A. More particularly, the lock pin 70 is formed such that it gradually becomes thick toward the bottom thereof and has a shape with which the rigidity can be assured comparatively readily.

As shown in FIGS. 3 to 6, an engaging groove 73 is formed over an overall circumferential face (circumferential region) of the annular member 56, and a fork member 74 for moving the annular member 56 is held in engagement with the engaging groove 73. The fork member 74 is formed in a substantially U shape as shown in FIG. 6 and is bifurcated and engaged with the engaging groove 73 in such a manner that the opposite end portions thereof sandwich the annular member 56.

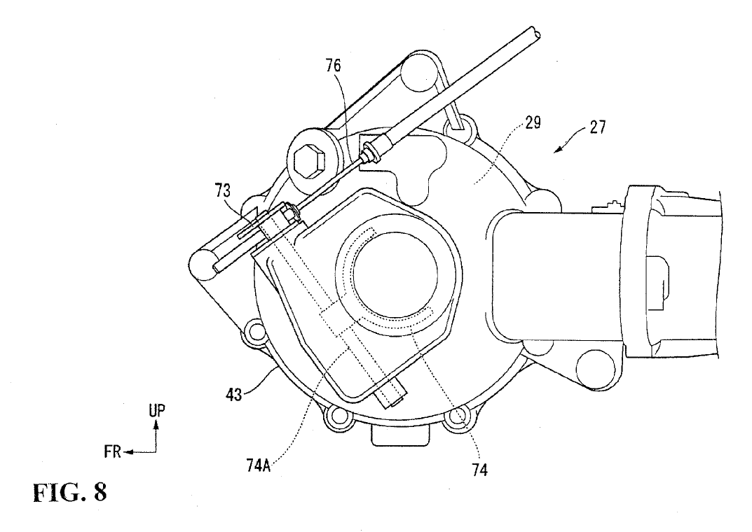

The fork member 74 is connected at an end portion opposite to the side on which it engages with the engaging groove 73, or in other words, at a bottom portion of the U shape hereof, to a lever shaft 74A. The lever shaft 74A is disposed on the opposite side to the diff case 49 with respect to the ring gear wheel 48 as shown, for example, in FIG. 3 and on the opposite side to the propeller shaft 25 with respect to the boss portion 54, and then extends in the upward and downward direction as shown in FIG. 8 such that an upper end thereof is opposed to the outside through the left half 43 (refer to a broken line in FIG. 8). The lever shaft 74A is connected at an upper end thereof to one end of a lever member 75 disposed above the left half 43 and extending in the vehicle widthwise direction, and a cable 76 is connected to the other end of the lever member 75. The lever member 75 is for moving the fork member 74 along the axial direction of the boss portion 54 in response to an operation of a rider and turns around the lever shaft 74A in response to a push-pull operation of the cable 76 coupled to a lever or the like operated by the rider. Consequently, the fork member 74 connected to the lever shaft 74A is moved, and the annular member 56 is moved along the guide portion 57.

FIG. 9 shows a view of the ring gear wheel 48 as viewed from the front (left side), and a plurality of pin holes 71 of the ring gear wheel 48 into which the lock pins 70 are inserted as shown in FIG. 9 are formed on a circumference of the boss portion 54 of the ring gear wheel 48. More particularly, three pin holes 71 are formed at equal intervals of 120 degrees on the circumference of the boss portion 54. Referring also to FIG. 5, each of the pin holes 71 is configured from an elliptic shallow hole portion 77 having a major axis in the direction of rotation of the ring gear wheel 48, and a deep hole portion 78 of a diameter smaller than that of the shallow hole portion 77, and has a multi-stage structure for allowing the lock pin 70 to be inserted therein smoothly. Referring also to FIG. 3, on a side face of the ring gear wheel 48 on the diff case 49 side, in other words, on a side face opposing to the left output side cam 65, that is, opposed to the left output side cam 65, an annular groove 79 having a circumference equal that of the pin hole 71 is formed. The annular groove 79 is for allowing dust, burr and so forth, which appear upon interference between the lock pin 70 and the left output side cam 65, to escape therethrough.

The pin hole 72 formed on the left output side cam 65 is formed on an end face of the left output side cam 65 on the ring gear wheel 48 side (side face, that is, a face opposite to the meshing side). Three such pin holes 72 are formed at intervals of 120 degrees in accordance with the number and formation positions of the lock pins 70 and the pin holes 71 and are formed as perforations of a diameter substantially same as that of the pin holes 71. The annular groove 79 of the ring gear wheel 48 described hereinabove has an annular shape of an equal circumference to that of the pin hole 72 along the locus of the pin hole 72 of the left output side cam 65. Also the pin hole 72 has a shape similar to that of the pin hole 71 and is configured from an elliptic shallow hole portion 80 having a major axis in the direction of rotation of the ring gear wheel 48 and a deep hole portion 81 of a diameter smaller than that of the shallow hole portion 80. Thus, the pin hole 72 has a multi-stage structure which allows the lock pin 70 to be inserted therein smoothly.

The operation of the diff lock R is hereinafter described. In the diff lock R of the configuration described above, if the annular member 56 is moved rightwardly by the fork member 74 until the lock pins 70 provided on the annular member 56 are inserted into the pin holes 71 of the ring gear wheel 48 and the pin holes 72 of the left output side cam 65, then the left output side cam 65 is integrated with the ring gear wheel 48 and the left output side cam 65 rotates together with the ring gear wheel 48. Consequently, the left output side cam 65 is integrated also with the input side blocks 63, . . . and 64, . . . without any relative slip therebetween. Since the left and right output side cams 65 and 66 are structured such that, in a state wherein the diff lock R does not operate, if one of the left and right output side cams 65 and 66 rotates relative to the input side blocks 63, . . . and 64, . . . , then also the other of the left and right output side cams 65 and 66 rotates independently together with the rotation, if the left output side cam 65 cannot be rotated any more relative to the input side blocks 63, . . . and 64, . . . as a result of operation of the diff lock R, then the right output side cam 66 stops its rotation. More particularly, the right output side cam 66 rotates integrally with the left output side cam 65 which rotates together with the ring gear wheel 48 and the diff case 49, and in other words, the differential mechanism section 50 is placed into a locked state wherein its operation is stopped. Consequently, the front wheels WF are rotated integrally by the same torque.

As described above, in the front wheel differential gear 29 of the present embodiment, as best shown in FIG. 2, the diff case 49 is attached to the side face of the ring gear wheel 48 opposite to the side on which the ring gear wheel 48 and the pinion gear wheel 35 mesh with each other, and the boss portion 54 with which the front axle 31L is fitted is provided integrally on the meshing side of the diff case 49 on which the ring gear wheel 48 meshes with the pinion gear wheel 35. The annular member 56 which can slidably move along the axial direction of the boss portion 54 is provided on the boss portion 54 and the guide portion 57 for guiding the annular member 56 is set on the annular member 56. Further, the lock pins 70 are provided on the annular member 56, and as the lock pins 70 are inserted into the pin holes 71 and 72 formed in the ring gear wheel 48 and the left output side cam 65, the differential motion of the differential mechanism section 50 is stopped, that is, a locked state is established. Then, the sliding region ST in which the annular member 56 slidably moves is disposed such that it is included in the projection region D of the diameter of the pinion gear wheel 35 on the extension line of the end portion in the axial direction of the pinion gear wheel 35.

With this configuration, since the differential mechanism section 50 is placed into a locked state by the ring gear wheel 48 and the left output side cam 65 which are high-strength members, the rigidity can be assured and the entire front wheel differential gear 29 need not formed with a great thickness. Further, since the meshing portion 48A with the front propeller shaft 25, the boss portion 54 and the annular member 56 and the lock pins 70 which are attached to the boss portion 54 are provided on the opposite side to the diff case 49 side which is comparatively great with respect to the ring gear wheel 48, the distance between the end portion of the propeller shaft and the driven shaft, that is, the length in the vehicle forward and backward direction, can be reduced. In short, if the meshing portion 48A of the ring gear wheel 48 is positioned on the attachment side of the ring gear wheel 48 to the diff case 49, it is necessary to increase the dimension of the ring gear wheel 48 in the diametrical direction by an amount corresponding to the thickness of the differential mechanism section 50 and the diff case 49 which accommodates the differential mechanism section 50. Therefore, the distance between the end portion of the front propeller shaft 25 and the driven shaft (front axles 31L and 31R) increases as much. However, where the meshing portion 48A and so forth are provided on the side face of the ring gear wheel 48 opposite to the attachment side of the diff case 49, the diameter of the ring gear wheel 48 can be reduced without being restricted by the thickness of the differential mechanism section 50 and the diff case 49. Further, since also the end portion of the front propeller shaft 25 can be extended to the front wheel differential gear 29 side and disposed, the distance between the end portion of the front propeller shaft 25 and the driven shaft, that is, the length in the vehicle widthwise direction, can be reduced.

Further, since the guide portion 57 (boss portion 54) of the annular member 56 having the lock pins 70 which require a predetermined length (stroke) is provided on the meshing side of the ring gear wheel 48 with the front propeller shaft 25, the guide portion 57 is positioned forwardly of the end portion of the front propeller shaft 25, and here, the sliding region ST within which the annular member 56 slidably moves is disposed on the extension line of the end portion in the axial direction of the pinion gear wheel 35 such that it is included in the projection region D of the diameter of the pinion gear wheel 35. Therefore, the region in the diametrical direction of the front propeller shaft 25 can be made the most of to reduce the width of the entire front wheel differential gear 29. Therefore, miniaturization of the front wheel differential gear 29 can be achieved, and the degree of freedom in layout of the vehicle can be improved. As a result, also miniaturization of the vehicle 1 can be implemented.

Further, as shown in FIGS. 2 and 3, the lever shaft 74A is disposed on the opposite side to the diff case 49 with respect to the ring gear wheel 48 and on the opposite side to the pinion gear wheel 35 with respect to the boss portion 54. Consequently, the dimension in the forward and backward direction and the leftward and rightward direction of the front wheel differential gear 29 can be reduced to achieve further compaction of the front wheel differential gear 29. In particular, although the space on the opposite side to the diff case 49 with respect to the ring gear wheel 48 and on the opposite side to the front propeller shaft 25 with respect to the boss portion 54 becomes a dead space in which no principal component is disposed, since the dead space can be utilized effectively by disposing the lever member 75 which is a moving mechanism for the annular member 56 and the lock pins 70, while the lock pins and the lever member are attached to the diff case 49 side, the length of the front wheel differential gear 29 in the forward and backward direction and the leftward and rightward direction can be reduced. Thus, further compaction is achieved.

Further, since the pin holes 71 formed on the ring gear wheel 48 are each configured from the elliptic shallow hole portion 77 having a major axis in the direction of rotation of the ring gear wheel 48 and the deep hole portion 78 of a diameter smaller than that of the shallow hole portion 77 and also the pin holes 72 of the left output side cam 65 are each configured from the elliptic shallow hole portion 80 having a major axis in the direction of rotation of the ring gear wheel 48 and the deep hole portion 81 of a diameter smaller than that of the shallow hole portion 80 as shown in FIG. 9 or the like, also insertion of the lock pins 70 into the pin holes 71 and 72 is facilitated. Further, by configuring the lock pin 70 from the large diameter portion 70A positioned on the bottom and the reduced diameter portion 70B of a diameter smaller than that of the large diameter portion 70A, the rigidity of the lock pin 70 is assured.

Furthermore, the annular groove 79 of an equal circumference is formed along the locus of the pin holes 72 of the left output side cam 65 on the side face of the ring gear wheel 48 as shown in FIGS. 8 and 9. Consequently, burrs produced in the pin holes 72 of the left output side cam 65 can escape by insertion and removal of the lock pins 70. Consequently, such burrs can be prevented from interfering with the ring gear wheel 48.

Further, in the present embodiment, the front wheel differential gear 29 is disposed, from the configuration, in a rightwardly offset relationship by a predetermined distance from the vehicle center line C1 in the vehicle widthwise direction as shown in FIGS. 1 and 2 and also the differential mechanism section 50 which is a heavy article is disposed in a rightwardly offset relationship by a predetermined distance. In contrast, the rear wheel differential gear 30, that is, the rear final assembly 28 which accommodates the rear wheel differential gear 30, is disposed in a displaced (offset) relationship to the left side substantially from the center in the vehicle widthwise direction. In the case of such disposition as just described, since the differential mechanism which is a heavy article is disposed in a distributed relationship substantially with respect to the center in the vehicle widthwise direction, the weight balance in the leftward and rightward direction of the vehicle body is improved. Further, a space is formed sidewardly of a rear portion of the rear final assembly 28 and the trailer hitch 24B is provided on the rear cross member 24A at a rear end of the center in the vehicle body widthwise direction while the rear wheel differential gear 30 is disposed in a displaced relationship such that it overlaps with a left portion of the trailer hitch 24B as viewed in a side elevation. With this configuration, the trailer hitch 24B can be disposed in a displaced relationship to the front side of the vehicle while avoiding interference between the rear final assembly 28 and the trailer hitch 24B which is disposed centrally of the vehicle. Therefore, the length in the forward and backward direction of the vehicle can be reduced. It is to be noted that, while, in the description of the present embodiment above, the configuration wherein the rear wheel differential gear 30, that is, the rear final assembly 28 which accommodates the rear wheel differential gear 30, is displaced leftwardly is described, another configuration wherein the front wheel differential gear 29 is displaced leftwardly while the rear wheel differential gear 30 is displaced rightwardly may be applied.

While an embodiment of the present invention has been described, the configuration of the embodiment described above is an example of the present invention, and it is a matter of course that various alterations can be made without departing from the subject matter of the present invention including the structure, shape, size, number, arrangement and so forth of the parts.

For example, while, in the embodiment described above, the front wheel differential gear 29 is a differential gear having a differential motion limiting mechanism (LSD: Limited Slip Differential), the present invention can be applied suitably also to a differential gear of a so-called open diff, that is, a popular differential gear wherein portions corresponding to the input side blocks 63, . . . and 64, . . . described in the description of the present embodiment are pinion gear wheels and portions corresponding to the left and right output side cams 65 and 66 are side gear wheels, and the present invention is not limited to the type of the differential gear. Further, while, in the description of the present embodiment, an example wherein the present invention is applied to the front wheel differential gear 29, the present invention can be applied suitably also to the rear wheel differential gear 30, and the present invention is not limited by the application such as applications for the front wheels or the rear wheels.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A differential gear for a vehicle which includes a ring gear wheel meshing with a pinion gear wheel provided on a propeller shaft which transmits a driving force from a driving source, a diff case attached to a side face of said ring gear wheel and forming a differential mechanism chamber, a differential mechanism accommodated in said diff case, a side gear wheel meshing with said differential mechanism for transmitting the driving force from said propeller shaft to wheels through driven shafts disposed on the left and the right, and a lock pin for stopping differential motion of said differential mechanism to place said differential mechanism into a locked state, comprising:
said diff case is attached to a side face of said ring gear wheel opposite to the side on which said ring gear wheel and said pinion gear wheel mesh with each other;
a boss portion integrally formed on said ring gear wheel wherein each of said driven shafts is fitted, on the meshing side thereof with said pinion gear wheel, and said boss portion has an annular member provided for sliding movement thereon along an axial direction of said boss portion and a guide portion for guiding said annular member is set to said boss portion;
said lock pin is provided on said annular member such that, when said annular member slidably moves until said lock pin is inserted into pin holes formed in said ring gear wheel and the corresponding side gear wheel, said differential mechanism is placed into a locked state, and a sliding region within which said annular member slidably moves is disposed so as to be included within a projection region of the diameter of said pinion gear wheel on an extension line of an end portion in an axial direction of said pinion gear wheel.

2. The differential gear for a vehicle according to claim 1, wherein said differential gear comprises:
a fork member for engaging with said annular member to sandwich a peripheral region of said annular member;
a lever member secured to said fork member for moving said fork member along the axial direction of said boss portion in response to an operation of a passenger to move said annular member; and
a lever shaft serving as a support shaft for said fork member and said lever member;
wherein said lever shaft is disposed on the opposite side to said diff case with respect to said ring gear wheel and on the opposite side to said pinion gear wheel with respect to said boss portion.

3. The differential gear for a vehicle according to claim 1, wherein the pin hole formed in said side gear wheel is formed from an elliptic shallow hole portion having a major axis in the direction of rotation of said ring gear wheel and a deep hole portion of a diameter smaller than that of said shallow hole portion, and a plurality of such pin holes are provided in said ring gear wheel.

4. The differential gear for a vehicle according to claim 2, wherein the pin hole formed in said side gear wheel is formed from an elliptic shallow hole portion having a major axis in the direction of rotation of said ring gear wheel and a deep hole portion of a diameter smaller than that of said shallow hole portion, and a plurality of such pin holes are provided in said ring gear wheel.

5. The differential gear for a vehicle according to claim 1, wherein said lock pin is formed from a large diameter portion positioned on the bottom and a reduced diameter portion having a diameter smaller than that of said large diameter portion, and a plurality of such lock pins are provided on said annular member.

6. The differential gear for a vehicle according to claim 2, wherein said lock pin is formed from a large diameter portion positioned on the bottom and a reduced diameter portion having a diameter smaller than that of said large diameter portion, and a plurality of such lock pins are provided on said annular member.

7. The differential gear for a vehicle according to claim 3, wherein said lock pin is formed from a large diameter portion positioned on the bottom and a reduced diameter portion having a diameter smaller than that of said large diameter portion, and a plurality of such lock pins are provided on said annular member.

8. The differential gear for a vehicle according to claim 1, wherein said pin hole formed on said ring gear is formed through the side face of said ring gear wheel along a circumferential direction of said ring gear wheel, and an annular groove having a circumference same as that of said pin hole is formed on the side face of said ring gear wheel opposing to said side gear wheel along a locus of said pin hole of said side gear wheel.

9. The differential gear for a vehicle according to claim 2, wherein said pin hole formed on said ring gear is formed through the side face of said ring gear wheel along a circumferential direction of said ring gear wheel, and an annular groove having a circumference same as that of said pin hole is formed on the side face of said ring gear wheel opposing to said side gear wheel along a locus of said pin hole of said side gear wheel.

10. The differential gear for a vehicle according to claim 3, wherein said pin hole formed on said ring gear is formed through the side face of said ring gear wheel along a circumferential direction of said ring gear wheel, and an annular groove having a circumference same as that of said pin hole is formed on the side face of said ring gear wheel opposing to said side gear wheel along a locus of said pin hole of said side gear wheel.

11. The differential gear for a vehicle according to claim 5, wherein said pin hole formed on said ring gear is formed through the side face of said ring gear wheel along a circumferential direction of said ring gear wheel, and an annular groove having a circumference same as that of said pin hole is formed on the side face of said ring gear wheel opposing to said side gear wheel along a locus of said pin hole of said side gear wheel.

12. The differential gear for a vehicle according to claim 1, wherein said differential gear is for front wheels of a vehicle which has seats juxtaposed in a vehicle widthwise direction and an engine disposed rearwardly of said seats and wherein said propeller shaft is disposed substantially at the center in the vehicle widthwise direction passing between said seats and a differential gear for rear wheels is disposed in a displaced relationship to one side from the substantial center in the vehicle widthwise direction, and said differential mechanism is disposed in a displaced relationship to the other side from the substantial center in the vehicle widthwise direction.

13. The differential gear for a vehicle according to claim 2, wherein said differential gear is for front wheels of a vehicle which has seats juxtaposed in a vehicle widthwise direction and an engine disposed rearwardly of said seats and wherein said propeller shaft is disposed substantially at the center in the vehicle widthwise direction passing between said seats and a differential gear for rear wheels is disposed in a displaced relationship to one side from the substantial center in the vehicle widthwise direction, and said differential mechanism is disposed in a displaced relationship to the other side from the substantial center in the vehicle widthwise direction.

14. The differential gear for a vehicle according to claim 3, wherein said differential gear is for front wheels of a vehicle which has seats juxtaposed in a vehicle widthwise direction and an engine disposed rearwardly of said seats and wherein said propeller shaft is disposed substantially at the center in the vehicle widthwise direction passing between said seats and a differential gear for rear wheels is disposed in a displaced relationship to one side from the substantial center in the vehicle widthwise direction, and said differential mechanism is disposed in a displaced relationship to the other side from the substantial center in the vehicle widthwise direction.

15. The differential gear for a vehicle according to claim 5, wherein said differential gear is for front wheels of a vehicle which has seats juxtaposed in a vehicle widthwise direction and an engine disposed rearwardly of said seats and wherein said propeller shaft is disposed substantially at the center in the vehicle widthwise direction passing between said seats and a differential gear for rear wheels is disposed in a displaced relationship to one side from the substantial center in the vehicle widthwise direction, and said differential mechanism is disposed in a displaced relationship to the other side from the substantial center in the vehicle widthwise direction.

16. The differential gear for a vehicle according to claim 8, wherein said differential gear is for front wheels of a vehicle which has seats juxtaposed in a vehicle widthwise direction and an engine disposed rearwardly of said seats and wherein said propeller shaft is disposed substantially at the center in the vehicle widthwise direction passing between said seats and a differential gear for rear wheels is disposed in a displaced relationship to one side from the substantial center in the vehicle widthwise direction, and said differential mechanism is disposed in a displaced relationship to the other side from the substantial center in the vehicle widthwise direction.

17. A vehicle including said differential gear according to claim 1, wherein said differential gear is mounted for front wheels of said vehicle wherein said propeller shaft is disposed at the substantial center in the vehicle widthwise direction and said differential mechanism of said differential gear is disposed in a displaced relationship to one side from the substantial center in the vehicle widthwise direction while a differential gear for rear wheels is disposed in a displaced relationship to the other side from the substantial center in the vehicle widthwise direction.

18. A vehicle including said differential gear according to claim 2, wherein said differential gear is mounted for front wheels of said vehicle wherein said propeller shaft is disposed at the substantial center in the vehicle widthwise direction and said differential mechanism of said differential gear is disposed in a displaced relationship to one side from the substantial center in the vehicle widthwise direction while a differential gear for rear wheels is disposed in a displaced relationship to the other side from the substantial center in the vehicle widthwise direction.

19. The vehicle according to claim 17, wherein a trailer hitch is provided on a vehicle body frame at a rear end of the center in the vehicle body widthwise direction, and said differential gear for said rear wheels is disposed in a displaced relationship in such a manner to overlap with one of the left and the right of said trailer hitch as viewed from sidewardly.

20. A differential gear adapted for use with a vehicle comprising:
a ring gear wheel meshing with a pinion gear wheel provided on a propeller shaft for transmitting a driving force from a driving source;
a diff case attached to a side face of said ring gear wheel and forming a differential mechanism chamber
a differential mechanism accommodated in said diff case;
a side gear wheel meshing with said differential mechanism adapted for transmitting the driving force from said propeller shaft to wheels through driven shafts disposed on the left and the right;
a lock pin for stopping differential motion of said differential mechanism to place said differential mechanism into a locked state;
said diff case being attached to a side face of said ring gear wheel opposite to the side on which said ring gear wheel and said pinion gear wheel mesh with each other; and
a boss portion integrally formed on said ring gear wheel wherein each of said driven shafts is fitted, on the meshing side thereof with said pinion gear wheel, and said boss portion has an annular member provided for sliding movement thereon along an axial direction of said boss portion and a guide portion for guiding said annular member is set to said boss portion;
said lock pin being provided on said annular member such that, when said annular member slidably moves until said lock pin is inserted into pin holes formed in said ring gear wheel and the corresponding side gear wheel, said differential mechanism is placed into a locked state, and a sliding region within which said annular member slidably moves is disposed so as to be included within a projection region of the diameter of said pinion gear wheel on an extension line of an end portion in an axial direction of said pinion gear wheel.
